(19) United States
(12) Patent Application Publication
(10) Pub. No.: US 2026/0370636 A1
(43) Pub. Date: Nov. 19, 2026

(54) SYSTEMS AND METHODS TO MANAGE USAGE OF A USER DEVICE

(71) Applicant: The Commons Inc., Saint Paul, MN (US)

(72) Inventors: Julia Gustafson, Saint Paul, MN (US); Shannon Godfrey, Long Beach, CA (US)

(73) Assignee: The Commons Inc., Saint Paul, MN (US)

(21) Appl. No.: 19/646,688

(22) Filed: Apr. 14, 2026

Related U.S. Application Data
(63) Continuation-in-part of application No. 19/211,372, filed on May 19, 2025.

(51) Int. Cl. H04L 9/40

(52) U.S. Cl. CPC H04L 63/08

(57) ABSTRACT

A system to control a user device associated with a user is disclosed. The system includes an access control unit that includes a memory and a processor. The memory stores usage rules. The processor obtains the usage rules from the memory. The usage rules comprise information associated with restriction on the user device. The processor monitors user activity data or device state signals across a plurality of applications and device states on the user device, and correlates the usage rules and the user activity data or the device state signals to determine an authorization state. Based on the authorization state, the processor monitors and evaluates compliance status of the user, and performs a remedial action based on the usage rules and the compliance status. The remedial action includes limiting or modifying access to one or more applications or device functions on the user device.

### CROSS-REFERENCE TO RELATED APPLICATION

The present application is a continuation-in-part application of US application No. 19/211,372, filed May 19, 2025, which is hereby incorporated by reference herein in its entirety.

### FIELD

The present disclosure relates to controlling a user device, and more specifically to a system and method to control usage of a user device.

### BACKGROUND

Education institutes face significant challenges from unrestricted phone use among students. Distractions caused by constant notifications, social media and mobile games make it difficult for students to concentrate during classes, often leading to lower academic performance of the students. Beyond academics, excessive phone use has been linked to rising concerns around student mental health, including increased anxiety, social withdrawal, and disrupted sleep patterns - particularly among adolescents. Cheating is another major concern, as students may look up answers online or share test materials using their devices.

To overcome these challenges, the education institutes have adopted a few policies. For example, education institutes use lockable phone pouches that allow students to keep their phones but prevent access until the end of the day. Lockable phone pouches help reduce the distractions but face issues like students tampering with or secretly bypassing them.

Accordingly, there is a need for a system and method that reliably prevents student access to personal devices within an educational environment—supporting both academic integrity and student well-being.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an environment in which techniques and structures for providing the systems and methods disclosed herein may be implemented.

FIG. 2 depicts a block diagram of a system to control a user device in accordance with the present disclosure.

FIG. 3 depicts an exemplary signal line diagram to control a user device in accordance with the present disclosure.

FIG. 4 depicts a first example view of an admin interface displaying a student overview in accordance with the present disclosure.

FIG. 5 depicts a second example view of an admin interface displaying student details in accordance with the present disclosure.

FIG. 6 depicts a third example view of an admin interface displaying an overall dashboard with a recommendation in accordance with the present disclosure.

FIG. 7 depicts a flow diagram of an example method to control a user device in accordance with the present disclosure.

FIG. 8 depicts an exemplary process to control a user device in accordance with a second embodiment of the present disclosure.

FIG. 9 depicts a flow diagram of an example method to control a user device in accordance with second embodiment of the present disclosure.

### DETAILED DESCRIPTION

### Overview

The present disclosure describes a system and method to prevent a user (e.g., a student) from using a user device (e.g., a mobile device or phone) inside a geographical area (e.g., an education institute). The system facilitates in managing and enforcing device usage rules or user device-free zones (or “smart zones”) effectively in the geographical area, thereby preventing distractions caused due to the use of user device inside the geographical area and enhancing user performance.

The smart zone may be a predefined zone or area (or a geofenced zone or a restricted zone) in which the system may prevent the use of the user device. The smart zone may define a geographic boundary or perimeter of the geographical area which may trigger the system to activate and enforce restrictions inside the smart zone. The system utilizes geofencing technology or any location / perimeter-based positioning technique to create the smart zones and prevent the use of the user device inside the smart zone. It may be appreciated that geofencing creates a virtual boundary or perimeter around a real-world geographic location using GPS or network data. The boundary can be circular or custom-shaped, defined by coordinates. The system enforces restrictions on the usage of user device when the user device enters the smart zone (such as the education institute or designated areas inside the education institute). The system may enforce the restrictions based on usage rules that are created/defined by an administrator (e.g., the education institute’s administrator, or the system’s administrator or developer/manager). The usage rules may be associated with the restrictions to be enforced on the user device when the user device is located in the smart zone.

For example, based on the usage rules, the system may deactivate/disable/block third party applications (e.g., applications associated with social media, entertainment, etc.), a network (e.g., Wi-Fi, mobile data plan, etc.), or other device functionality associated with the user device when the user device is located inside the smart zone. The system may disable all the third-party applications, or may selectively disable one or more third party applications installed on the user device and selectively allow other third-party applications (e.g., health related applications) to operate on the user device based on the usage rules. Further, the usage rules may include information associated with a defined schedule of the day (e.g., class hours between 8 AM to 3 PM or specific hours during evenings or weekends) to activate/enforce the restriction on the user device, a defined day or days (e.g., weekdays, weekends, or specific calendar dates) to enforce the restriction on the user device, a defined location or zone in the smart zone (e.g., library, classrooms in the education institute, dormitories, or other designated areas) to enforce the restriction on the user device, and/or the like.

In some aspects, the system utilizes an agent located on the user device associated with the user, to enforce the restrictions described above. The agent may include instructions stored thereupon which, when executed by a user device processor, cause the user device processor to enable the system to enforce/implement restrictions on the user device. The system may be hosted on a server, and may communicatively couple with the agent via a network connection.

In some aspects, the system and the agent may actively limit applications, network traffic and native capabilities of the device while within the smart zone. The system and the agent may use one or more content filtering, tunneling, or network-routing mechanisms, such as a Virtual Private Network (VPN), application blocking, or equivalent technology to restrict the user device’s usage inside the smart zone. In some aspects, the system and the agent may establish a VPN connection for the user device to restrict the user device usage inside the smart zone. It may be appreciated that the VPN routes all internet traffic through a controlled gateway where restrictions may be enforced. This allows the system to block/restrict the user device usage, such as prevent the user from accessing websites, social media apps, internet, etc.

In further aspects, the system may monitor compliance status of the user device (e.g., via the agent) and may log the compliance status in a system memory. The compliance status may be associated with a predefined permission for the agent to enable the system to enforce the restriction on the user device. In an exemplary aspect, the user device may be in a non-compliant state when the user disables the predefined permission (e.g., location tracking feature and/or the VPN) for the agent to operate properly. In another exemplary aspect, the user device may be in the non-compliant state when the user removes/deletes the agent from the user device. On the other hand, the user device may be in the compliant state when the agent has the predefined permission to operate properly on the user device and the user has not removed the agent from the user device.

Responsive to determining that the user device is in the non-compliant state, the system may perform one or more remedial actions (e.g., outputting an alert notification to the user device and/or to a third party such as parent, supervisor/teacher, etc.). The system may further monitor user device usage (e.g., active screen time) when the user device is inside the smart zone. In some aspects, the system may monitor the user device usage when the user device may be in the non-compliant state, and may store such information in the system memory.

The system may further generate and render a dashboard depicting the compliance status and/or the user device usage information (real-time and historical data) on an admin interface associated with the administrator (e.g., on a computing device associated with the administrator). The dashboard may further include user performance (e.g., academic performance associated with the user). The dashboard may enable the administrator to view different information about the user collectively, correlate all the information and counsel the user based on the correlation. In some aspects, the system may correlate the user performance and the other information (including the compliance status and/or the user device usage information), and determine a recommendation to improve the user’s performance based on the correlation. The system may further predict a future performance outcome of the user based on the correlation, and may display a notification indicating the prediction and/or the recommendation on the user device and/or the admin interface.

The system may also track device usage patterns and compliance status to generate insights around engagement, productivity, or adherence to location-specific policies - whether for academic, operational, or safety-related outcomes. This enables administrators or supervisors across educational, professional, or event-based environments to make informed decisions that support well-being, performance, and policy effectiveness.

In accordance with further embodiment of the present disclosure, the system may incorporate and utilize automated rules to trigger activation and deactivation of user devices or their application states, thereby restricting usage of user devices within the geographical area. In some aspects, the system may support activation and deactivation of the user device or application states based on one or more contextual triggers, which may operate independently or in combination. In an exemplary aspect, the contextual triggers may be based on the location of the user / user device. For instance, the system may activate the restriction when the user (carrying the user device) enters the education institution. Additionally or alternatively, the system may activate the restriction when the user enters a specific area within the education institute, such as a classroom or a specific zone. In some aspects, the system enforces/activates restrictions on the usage of the user device when the user device enters the geographic area (such as the education institute or a designated area inside the education institute).

In other aspects, the contextual triggers may not always be based on the user device’s location, but may be based on other factors as well. In some cases, activation and deactivation of device restrictions may occur independently of geographic location and may instead be triggered by contextual interactions between the user, the device, and the educational environment. For example, the system may activate the restriction during defined academic hours or schedule. In another example, the system may activate the restriction when the user taps the user device on a Near field communication (NFC) tag, scans a quick-response (QR) code, interacts with another proximity marker or digital checkpoint, enters predefined credentials on the user device, and/or the like. In some cases, activation or deactivation of device restrictions may occur through check-in or check-out events associated with entering, exiting, or transitioning within an managed environment. In yet another example, the system may activate the restriction based on the role of the user (e.g., whether the user is a student, a faculty member, an administrative staff, a visitor, or an authorized personnel). In yet another example, the system may activate the restriction based on one or more policies defined by the education institute. In addition, the system may activate the restriction based on manual inputs such as teacher-initiated class mode.

The system incorporates different mechanisms (or contextual triggers) to activate or deactivate the user device or its application states. The administrator may select one or more contextual triggers from a list of contextual triggers to enforce the restriction. In this manner, the system provide flexibility to the education institution to select preferred mechanism(s) or contextual triggers, which would fit the respective environment, to activate or deactivate the user devices or application states within the education institution. These triggers may be used by the system to activate or deactivate the user device automatically, semi-automatically, or manually, and may apply to individual users or defined groups of users. In some aspects, information associated with the contextual triggers may be stored in the usage rules in a system memory, which indicates “when” to activate/deactivate restrictions on the user device. The usage rules may be defined by the administrator.

In addition to the contextual triggers, the usage rules may include information associated with “what” restrictions (e.g., type of restriction) need to enforced on the user device when the restriction is activated. In this way, the system aligns the operational state of the user device with the policies and expectations defined by the managed environment. For example, based on the usage rules, the system may deactivate/disable/block third party applications (e.g., applications associated with social media, entertainment, etc.), the network (e.g., Wi-Fi, mobile data plan, etc.), or other device functionalities when the restriction is activated, as described above. In an exemplary aspect, once the restriction is activated, the system may disable all the third-party applications and device functionalities, or may selectively disable one or more third party applications installed on the user device (and/or device functionality) and selectively allow other third-party applications (e.g., health related applications) to operate on the user device (and/or device functionality) based on the usage rules.

In some aspects, the system may enable/disable full or specific applications, or defined device functions based on context, policy, role, schedule, or authorization state. Some or most of these parameters may be defined by the administrator as part of the usage rules described above. For instance, the usage rules may include information associated with authorized usage (or approved use) of the user device in which the device or the application usage is explicitly authorized for a defined purpose, time period, role, or context. The authorized state of the device usage or application usage may be time-bound, context-specific, or applied to individual users or defined groups (e.g., classes, grades, roles, or device categories). For example, the system may allow 9^{th} graders to use specific applications during a specific class session. In another example, the usage of applications that are otherwise permitted by policy (e.g., whitelisted educational applications) may be explicitly authorized during a class session. In addition, the usage rules may include information associated with unauthorized usage (or restricted use) of the user device in which the device or the application usage is limited in accordance with policy. For instance, the system may not allow user device usage inside library. Further, the usage rules may include information associated with a “class mode” in which temporary, context-specific permissions are granted based on instructional needs, teacher input, schedule, or location.

In further aspects, the system may continuously monitor the user activity on the user device (e.g., when the user is located within the education institute) and evaluate user compliance based on the usage rules. The system evaluates the compliance through multiple signals including, but not limited to, device state, permission status, application status, activation context, and authorization state. The system may evaluate device activity in relation to the policies, authorization states, and contextual triggers that apply within the managed environment. Usage occurring during authorized states may be interpreted differently from unauthorized usage for the purposes of compliance evaluation, analytics, reporting, and behavioral assessment. In some aspects, the system may determine that the user is compliant when the user uses the user device or application(s) when the user is approved to use the device or application. For example, when the device usage or application usage is approved for the class session, increased device usage during that period is recorded as approved instructional use rather than non-compliant behavior. The system may determine non-compliant behavior when the user disables predefined permission (e.g., location tracking feature and/or the VPN on the device) for the system to operate properly, or the user uses the device in scenarios where user device usage is not permitted.

Compliance is evaluated not solely on technical enforcement, but on contextual interpretation, including differentiation between authorized usage occurring during approved instructional or policy-defined contexts; unauthorized usage occurring outside approved contexts; or repeated inability or failure to comply with defined expectations. The system may log, aggregate, and analyze compliance data over time to support differentiated responses, interventions, recommendations, or policy adjustments. The system may log the compliance status in the system memory. Further, the system may register when device usage or application usage is authorized, rather than merely unblocked. The system distinguishes between device functionality that is technically available and device functionality that has been explicitly authorized within a defined policy or instructional context. For instance, teachers (or administrators or automated policies) may temporarily allow access to specific applications, services, or device functions while the system records that such access was explicitly approved.

Responsive to determining that the user device is in the non-compliant state, the system may perform one or more remedial actions based on the usage rules. In some cases, the system may deactivate or disable (or alternatively selectively activate or enable) third party applications (e.g., applications associated with social media, entertainment, etc.), a network or other device functionality associated with the user device to control the device usage or application usage. The system may disable all the third-party applications, or may selectively disable one or more third party applications installed on the user device and selectively allow other third-party applications (e.g., health related applications) to operate. The system may customize restrictions for the user device based on the usage rules defined by the administrator.

In some aspects, the system may apply a tiered response / escalation model to control the device usage or application usage. The tiered approach to controlling multiple device and application states offers a structured, scalable method for regulating user device usage, moving from passive awareness to active, automated restriction. The number, sequence, and enforcement characteristics of restriction tiers may vary across implementations and may include two, three, or more tiers. This approach is highly effective because it treats digital well-being as a dynamic process rather than a one-time fix, allowing users to tailor their interventions based on their specific habits and needs.

To apply the tiered response / escalation model, the usage rules may include information associated with a plurality of restriction tiers (e.g., two, three, or more tiers), which indicates “how” the restrictions need to be enforced. In an exemplary aspect, the plurality of restriction tiers may include a first restriction tier, a second restriction tier, and additional restriction tiers, where each restriction tier represents a progressively different level of restriction applied to the user device or application states. In some implementations, an initial restriction tier (e.g., a first restriction) may apply a soft restriction on the device usage or application usage. For instance, the system may output a notification to the user, via the user device, indicating the device or application’s unauthorized usage when the first restriction tier is enforced or implemented. In some aspects, the system may not perform any active control (e.g., block the application(s) or the device functions) when the first restriction tier is enforced. In one or more subsequent restriction tiers (e.g., second restriction), increasingly active restrictions on user device usage may be imposed. This involves blocking all or selective applications on the user device, locking down device functionality, and/or the like.

The system may select and apply the one or more restriction tiers based on the monitoring of device usage or application usage and the usage rules. For instance, when the user activity data indicates less usage (e.g., less than a threshold value) during the unauthorized use, the system may apply an initial restriction tier and send a notification (e.g., guidance or intervention) to the user to stop using the device or application. After receiving the notification, if the user continues to use the device or application for a prolonged time duration (e.g., greater than the threshold value), the system may enforce to one or more subsequent restriction tiers to actively apply restrictions based on the usage rules.

The system may adjust restrictions, guidance, or interventions in the tiered response model based on observed behavior, compliance patterns, or policy criteria. In some aspects, the tiered responses may vary by individual student, policy or role, or repeated behavior patterns or historical compliance signals. The system may apply more restrictive tiers (e.g., additional OS-level controls, parental involvement, or enhanced supervision) selectively rather than universally, allowing the system to respond proportionally to demonstrated need. In some aspects, the system utilizes the agent located / installed on the user device, to enforce the restrictions described above. The device-resident agent may communicate with a remote system (or the system) that manages policies, authorization states, and compliance signals to coordinate enforcement of device restrictions on the user device.

The system may aggregate data and generate insights based on the aggregated data. For instance, the system may generate behavioral, usage, and compliance insights derived from device activity, activation context, and the authorization state. The system may synchronize such insights with external systems (e.g., student information systems or other school platforms). The system is designed to feed insights outward rather than solely displaying the dashboards internally, enabling downstream use of system-generated intelligence. The system may use the insights to perform risk identification, attendance or engagement tracking, interventions or support workflow generation, or incentive or reward program identification. For instance, the system may use the insights to detect potential academic, mental, or physical health issues. In addition, the system may provide support or personalized content to the user based on the insights, which would reinforce positive behavior in the user.

In addition, to reinforce positive behavior in the user, the system may aggregate compliance history, authorization states, and device interaction signals and classify the users into performance-based cohorts. For instance, the system may classify the users into consistently compliant users; intermittently compliant users; or users exhibiting repeated difficulty maintaining compliance. Based on such classifications, the system may deliver differentiated guidance, encouragement, educational content, or supportive messaging intended to reinforce positive behavior and support sustainable habit formation. The system may deliver behavioral reinforcement content within the application associated with the system or through approved communication channels that operate in coordination with the system’s compliance monitoring, authorization states, and tiered response model.

In some scenarios, the system supports out-of-application communication mechanisms to reinforce compliance, support behavior change, and reduce administrative burden. The system may generate the communication based on device state, compliance signals, behavioral patterns, authorization context, and/or policy criteria. Responsive to generating the communication, the system may deliver the communication through one or more channels, including: email, text message (SMS), push notifications, or other electronic messaging mechanisms. The system may direct the messages to students, parents or guardians, teachers, and administrators; and the messages may be customized based on role, behavior patterns, or escalation level. Student-facing communications are designed to support habit formation and self-regulation rather than punitive enforcement. Parent and administrator communications may provide visibility into patterns, escalation thresholds, or support needs without exposing granular activity data.

A core objective of the system is to reduce operational friction for schools and students by allowing flexible selection of activation methods, authorization states, and enforcement intensity. Examples of friction-reducing configurations include: school-wide vs classroom-based activation; automated vs teacher-initiated activation; passive vs active student interaction requirements, etc. The system is designed to adapt to varying school environments while maintaining consistent policy intent and compliance monitoring.

The present disclosure discloses a system to enforce phone-free zones effectively in an education institute, and prevent distraction caused due to phone usage inside the education institute, thereby enhancing academic performance and student well-being. The system enhances student/user engagement, focus, and learning during education institute hours. The system drives change in learning environment through sustainable policy and program fidelity. The system further encourages presence, meaningful relationships and positive behavior by removing social media, increasing phone-use awareness and providing learning opportunities for digital citizenship. The system further enables the supervisors/teachers to focus on providing learnings to the users rather than monitoring the users and preventing them to use phones during classes.

The system automatically removes the ability to use social media applications from the user’s phones, and provides data-driven visibility to support policy enforcement and sustainability. Real-time dashboards provide visibility into active/inactive users allowing school administrators quick access to necessary interventions if needed during operational hours within education institute premises under defined schedules set forth by respective authorities managing these systems effectively without any hassle. The system tracks active screentime to promote student self-awareness but also to assist administrators in identifying patterns of overuse or noncompliance that may serve as indicators of disengagement, behavioral concerns, or the need for additional support or intervention. The system further enables real-time engagement and compliance monitoring. These and other advantages of the present disclosure are provided in detail herein. By providing flexible enforcement and monitoring tools, the system is well-suited for a variety of environments where controlled use of personal mobile devices supports individual performance, policy compliance, or safety protocols.

While the present disclosure emphasizes education-related use cases, the system and methods described herein are equally applicable in other environments where digital distraction poses operational, safety, or productivity concerns such as corporate offices, events, training facilities, or entertainment venues. The present disclosure is not limited to educational settings and may be implemented in any managed environment where digital distraction, safety considerations, or productivity concerns exist. Accordingly, the “user” may refer to any individual carrying a mobile/user device including, but not limited to, students, employees, event participants, or attendees at public or private venues.

### Illustrative Embodiments

The disclosure will be described more fully hereinafter with reference to the accompanying drawings, in which example embodiments of the disclosure are shown, and not intended to be limiting.

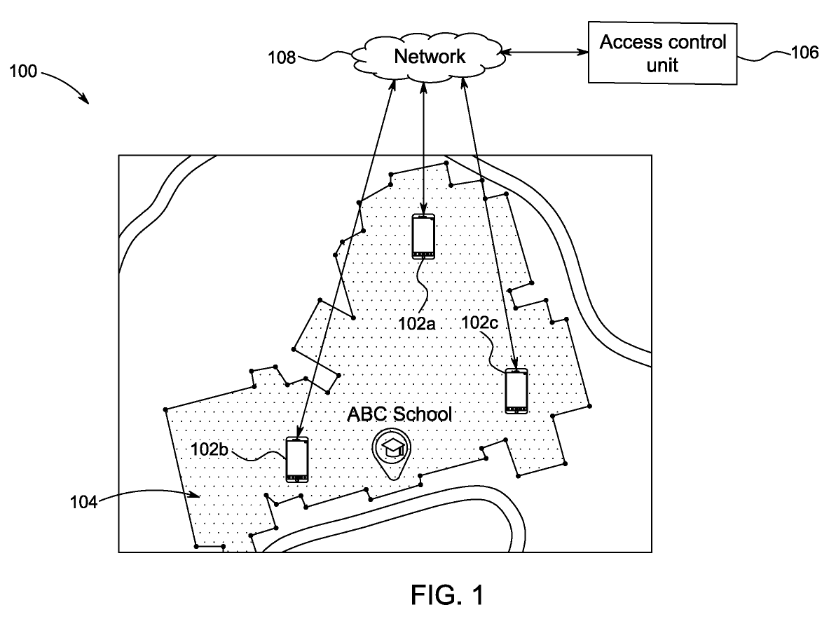

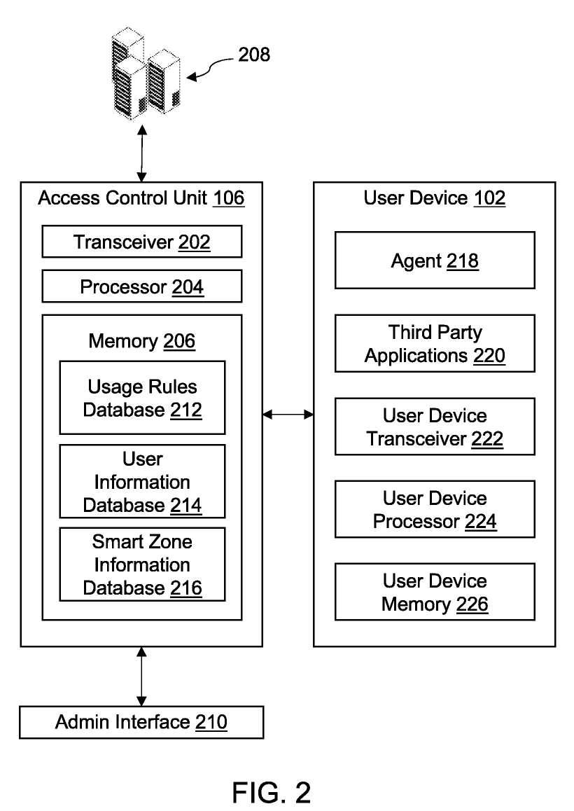

FIG. 1 depicts an environment 100 in which techniques and structures for providing the systems and methods disclosed herein may be implemented. FIG. 1 will be described in conjunction with FIGS. 2, 3, 4, 5 and 6.

The environment 100 may include one or more user devices 102a, 102b, 102c (collectively referred as user device 102), which may be associated with one or more users (e.g., students of an education institute, employees of a corporate, etc.). The user device 102 may be, for example, a mobile phone, a laptop, a tablet, a smartwatch, or any other similar device with communication capabilities.

The environment 100 may further include a smart zone 104 (which may be a geofenced zone or a restricted zone). The smart zone may define a geographic boundary or perimeter of a geographical area. In some aspects, the smart zone may be created by using geofencing technology or any location / perimeter-based positioning technique. It may be appreciated that geofencing creates a virtual boundary or perimeter around a real-world geographic location using Global Positioning System (GPS) or other means of position interpretation such as beacons or network data. The boundary may be circular, polygonal, or custom-shaped, defined by coordinates. The geographic location may include, but is not limited to, an education institute, a workplace (e.g., an office), a room in a home, a factory / plant, a mill, and/or the like.

The environment 100 may further include an access control unit 106 (or unit 106) that may control the usage of the user device 102 inside the smart zone 104 (or the geographical area). For example, the unit 106 may deactivate or disable (or alternatively selectively activate or enable) third party applications (e.g., applications associated with social media, entertainment, etc.), a network (e.g., a network 108 described below), or other device functionality associated with the user device 102 when the user device 102 is located inside the smart zone 104. The unit 106 may disable all the third-party applications, or may selectively disable one or more third party applications installed on the user device 102 and selectively allow other third-party applications (e.g., health related applications) to operate. The unit 106 may customize restrictions for the user device 102 based on the preferences of an administrator (e.g., an education institute’s administrator, or unit’s administrator or developer/manager). The unit 106 may communicatively couple with the user device 102 via the network 108.

The network 108, as described above, illustrates an example communication infrastructure in which the connected devices discussed in various embodiments of this disclosure may communicate. The network 108 may be and/or include the Internet, a private network, public network or other configuration that operates using any one or more known communication protocols such as transmission control protocol/Internet protocol (TCP/IP), Bluetooth^{®}, Bluetooth^{®} Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The environment 100 may further include an agent (shown as agent 218 in FIG. 2) that may be installed on the user device 102. In an exemplary aspect, the agent 218 may be an application (“app”) associated with the unit 106 that may be located on the user device 102. The agent 218 may be communicatively coupled with the unit 106 via the network 108. The agent 218 may enable the unit 106 to activate the restrictions on the user device 102 when the user device 102 may be located in the smart zone 104. The agent 218 may receive a trigger signal when the user device 102 enters the smart zone 104, and may enable the unit 106 to activate the restrictions on the user device 102 when the user device 102 is located inside the smart zone 104.

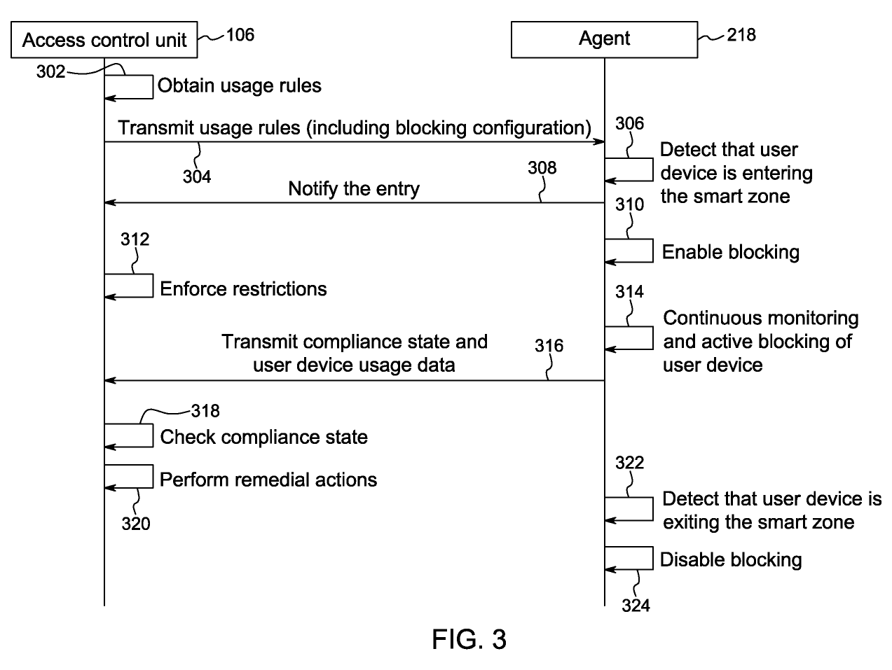

In some aspects, the unit 106 and the agent 218 may actively limit applications, network traffic and native capabilities of the user device 102 while within the smart zone 104. The unit 106 and the agent 218 may use one or more of content filtering, tunneling, or network-routing mechanisms, such as a Virtual Private Network (VPN), application blocking, or equivalent technology to restrict the user device’s usage inside the smart zone 104. In some aspects, the unit 106 and the agent 218 may establish a VPN connection for the user device 102 to restrict the user device usage inside the smart zone 104. It may be appreciated that the VPN routes all internet traffic through a controlled gateway where restrictions may be enforced. This allows the unit 106 to block/restrict the user device usage, such as prevent the user from accessing certain websites, social media apps, Internet, etc. The details of actions performed by the unit 106 and the agent 218 installed on the user device 102 are described later in the described below (e.g., in conjunction with FIG. 3).

The unit 106 may include a plurality of components including, but not limited to, a transceiver 202, a processor 204 and a memory 206, as shown in FIG. 2. The unit 106 may be communicatively coupled or integrated with an external server 208 via the network 108. In some aspects, the external server 208 may be associated with the education institute and may be managed by the education institute. For instance, the external server 208 may store details associated with all the students/users in different classes (e.g., student name, historical grades associated with each student or historical student performance, supervisors/teachers’ information for each class (e.g., supervisor name, total experience, etc.), curriculum of each subject/supervisor, and/or the like). An administrator may use the unit 106 (and the agent 218 installed on the user device 102) to enforce the restriction on the user device 102, via an admin interface 210 (that may be rendered on a computing device associated with the administrator).

The transceiver 202 may receive data / information / signals from the unit 106 components and/or external systems, e.g., the user device 102 via the network 108 described above. For example, the transceiver 202 may receive location information associated with the user device 102 from the agent 218, other information (e.g., real-time user device usage data) associated with the user device 102 from the agent 218, details of students/users from the external server 208, and/or the like. The transceiver 202 may further output information/data on the admin interface 210, the user device 102, etc. In some aspects, the transceiver 202 may exchange information/data with the agent 218 (and other devices) in a secured environment so that there is no compromise/leakage of data while data exchange. In an exemplary aspect, all communications use TLS 1.2 or higher to ensure data security over-the-wire.

The processor 204 may utilize the memory 206 to store programs in code and/or to store data for performing aspects in accordance with the disclosure. The memory 206 may be a non-transitory computer-readable storage medium or memory storing a program code that enables the processor 204 to perform operations in accordance with the present disclosure. The memory 206 may include any one or a combination of volatile memory elements / media (e.g., dynamic random-access memory (DRAM), synchronous dynamic random-access memory (SDRAM), etc.) and may include any one or more nonvolatile memory elements / media (e.g., erasable programmable read-only memory (EPROM), flash memory, electronically erasable programmable read-only memory (EEPROM), programmable read-only memory (PROM), etc.).

In some aspects, the memory 206 may include a plurality of databases including, but not limited to, a usage rule database 212, a user information database 214 and a smart zone information database 216. The usage rule database 212 may store usage rules associated with the restrictions to be enforced on the user device 102 when the user device 102 may be located in the smart zone 104. The administrator (e.g., the unit developer/manager or the education institute’s administrator) may define/create the usage rules on the unit 106 (e.g., via the admin interface 210), which may be stored on the usage rule database 212.

The usage rules may include location information associated with the smart zone 104 (that may enable the agent 218 to know the smart zone boundary), and the restriction to be enforced on the user device 102 when the user device 102 is inside the smart zone 104. For example, the usage rules may define that the unit 106 should deactivate third party applications (e.g., applications associated with social media, entertainment, etc.), the network 108, and/or the other device functionality associated with the user device 102 when the user device 102 is located inside the smart zone 104. The unit 106 may customize the restrictions for the user device 102 based on the administrator’s preferences that the administrator defines in the usage rules, via the admin interface 210.

Further, the usage rules may include information associated with a defined schedule of the day to activate/enforce the restriction on the user device 102 (e.g., enforce the restriction between 8 AM to 2 PM), a defined day or days (e.g., weekdays, weekends, or specific calendar dates) to enforce the restriction on the user device 102 (enforce the restriction on weekdays), a defined location or zone in the smart zone 104 (e.g., library, classrooms, event place in the education institute) to enforce the restriction on the user device 102, and/or the like. The usage rules may be associated with the smart zone 104 (e.g., the education institute) and may be defined/created by the administrator via the admin interface 210. In addition, the administrator may set the virtual boundaries for geofencing a geographical location, such as the education institute, or define the smart zone 104 via the admin interface 210.

The user information database 214 may store information associated with students / users associated with the education institute. The transceiver 202 may obtain the user details / information from the external server 208 and store the details in the user information database 214. The administrator may modify/update the user’s details in the user information database 214 anytime via the admin interface 210. The smart zone information database 216 may include details associated with the smart zone 104, which may include, e.g., perimeter details and/or location details associated with the smart zone 104. The administrator may customize the details associated with the smart zone 104 via the admin interface 210. In some aspects, the smart zone information database 216 may be part of the usage rule database 212. In other aspects, the smart zone information database 216 may be separate from the usage rule database 212, as depicted in FIG. 2.

The user device 102 may include a plurality of components / units including, but not limited to, the agent 218 associated (or communicatively coupled) with the unit 106, third party applications 220, a user device transceiver 222, a user device processor 224 and a user device memory 226. The agent 218 may be located on the user device 102. The agent 218 may include instructions stored thereupon which, when executed by the user device processor 224, cause the user device processor 224 to enable the unit 106 to enforce/implement the restriction on the user device 102 (and control other operations, as described below). The user device transceiver 222 may exchange data/information with external devices/systems. For instance, the user device transceiver 222 may exchange data/information with the unit 106. The user device processor 224 may be similar to the processor 204, and the user device memory 226 may be similar to the memory 206.

In operation, the unit 106 may obtain a list of users/students (along with their respective user information such as user names, grades, etc.) from the external server 208 via the network 108, for whom the restrictions are required to be enforced on their respective user devices when the user devices are located in the smart zone 104. In some aspects, the unit 106 may obtain the list from the external server 208 at a predefined frequency (e.g., to maintain an updated list of users). The unit 106 may generate a unique quick-response (QR) code for each user, responsive to obtaining the list and the respective user information. It may be appreciated that a QR code is a way to store information visually using a pattern of black and white squares. It’s like a barcode, which can hold more complex data, such as a link to install the agent 218 (or an application associated with the unit 106). The unit 106 may transmit the QR code for each user to the administrator, who may distribute the QR codes to respective users. Alternatively, the unit 106 may directly transmit the QR codes to respective user devices.

Each user may use the unique QR code to install the agent 218 on the user device 102 associated with the user. The unit 106 may leverage the QR code to communicatively couple or link the unit 106 with the user device 102. Stated another way, the QR code may enable the unit 106 to pair with the user device 102. In some aspects, the uer may use the QR code for one-time activation of the agent 218 on the user device 102, and to pair the user device 102 with the unit 106. Stated another way, the unit 106 may generate the unique QR code for each user device associated with the user, and enable the user to install the agent 218 on the user device 102 by using the QR code to communicatively couple or link the user device 102 with the unit 106. The QR code may allow the user device 102 to activate the agent 218 on the user device 102.

In an exemplary aspect, the unit 106 may store a mapping of each generated QR code with the respective user information (obtained from the external server 208), which may enable the unit 106 to identify the user device (e.g., a user device ID) associated with the respective user. Stated another way, the unit 106 may match the QR code to the user identity (or user information) to link the user device 102 with the user (or authenticate the user device 102). Thus, the QR code may enable the unit 106 to uniquely identify the user device 102 and the user associated with the user device 102. In this way, the user is not required to provide any Personally Identifiable Information (PII) on the user device 102, and the unit 106 may automatically identify that the user device 102 belongs to the user by using the unique QR code associated with the user. In some aspects, the unit 106 may utilize local encrypted storage via Hive database for storing sensitive information like the user device ID and the user information.

In this manner, the unit 106 may perform secure device authentication using roster-based authentication and not user-based authentication. A roster provides a list of users (students, teachers, etc.) and their associated roles or groups, which may be maintained in a student information system (SIS) or student management system (SMS) (which may be part of or stored on the external server 208). As described above, the external server 208 may be maintained by the education institute (as an example). Roster-based authentication refers to synchronizing user accounts and permissions from the external server 208 with the unit 106. The unit 106 automatically adds, removes, and updates users based on the data in the roster (or the external server 208), ensuring that the users have appropriate access to the services associated with the unit 106. In some aspects, the authentication process uses a temporary token that allows the agent activation but does not link to the personal user records. In scenarios where extra verification is required, the unit 106 may request for last four digits of a code, which is not stored beyond an initial validation.

When the agent 218 is installed / located in the user device 102, the agent 218 may output a notification on a user device interface, requesting the user to enable one or more predefined permissions (or necessary permissions) for the agent 218 to operate on the user device 102 (e.g., to enforce the restriction on the user device 102 via the unit 106). The predefined permissions may include access to multiple device capabilities including but not limited to, a permission to track location of the user device 102 and/or a permission to establish a VPN connection to enable the unit 106 to enforce the restriction on the user device 102 via the VPN. The user may view the notification on the user device interface and may enable/accept the predefined permissions to allow the agent 218 to operate or run on the user device 102. When the user approves or enables the predefined permissions on the user device 102, the agent 218 and the unit 106 may perform actions that are described below in conjunction with FIG. 3.

The processor 204 may first obtain / fetch the usage rules associated with the user device 102 from the usage rules database 212, as shown in a step 302. As described above, the usage rules may include information associated with the smart zone 104 and the restriction to be enforced on the user device 102 inside the smart zone 104. The processor 204 may transmit the usage rules to the agent 218 via the network 108 and the transceiver 202, responsive to obtaining the usage rules, as shown in a step 304. In some aspects, the usage rules may include a blocking configuration (e.g., a VPN configuration) that may actively limit applications, network traffic and native capabilities of the user device 102 while within the smart zone 104. The agent 218 may obtain the blocking configuration / settings from the unit 106.

The agent 218 may obtain the usage rules from the unit 106, and may track/monitor the user device location relative to the smart zone 104, responsive to obtaining the usage rules. For instance, the agent 218 may track and detect/determine whether the user device 102 may be entering the smart zone 104 via a GPS associated with the user device 102 (or the user device 102 is within the smart zone 104), as shown in a step 306. The agent 218 may receive a trigger signal from the user device processor 224 when the user device 102 is entering the smart zone 104 (e.g., via location tracking / GPS). Responsive to obtaining the trigger signal, the agent 218 may output a first notification to the unit 106 indicating that the user device 102 is entering the smart zone 104, as shown in a step 308.

In addition, the agent 218 may enable blocking based on the usage rules / blocking configuration (as shown in a step 310) when the agent 218 detects that the user device 102 is entering or has entered the smart zone 104. For instance, the agent 218 may activate VPN to route the network traffic on the user device 102 through a VPN gateway/tunnel to restrict the user device usage in the smart zone 104. In some aspects, once the VPN is activated, the agent 218 may output a second notification to the unit 106. The second notification may include an indication that the agent 218 has activated the VPN on the user device 102 based on the VPN configuration, and metadata associated with the activation (e.g., timestamp, location, etc., at which the VPN is activated).

Responsive to enabling the blocking, the unit 106 (or the processor 204) may enforce network-level controls or activate the restriction on the user device usage based on the usage rules when the user device 102 is located in the smart zone 104, as shown in a step 312. In some aspects, the unit 106 may enforce network-level controls or activate the restriction on the user device’s usage via the VPN gateway. The unit 106 may further log or store all the activities (including metadata obtained from the agent 218). The unit 106 may enforce the restrictions based on the usage rules stored in the usage rules database 212. For example, the unit 106 may disable all the third party applications 220 (or selective third party applications) for the user device 102 during 8 AM till 3 PM on weekdays. In another example, the unit 106 may block the internet in designated areas, such as the library and/or examination halls to prevent sharing of materials or cheating. Similarly, the unit 106 may temporarily activate the restrictions during an event or assembly so that the users may focus on the event / assembly, rather than on the user devices. In addition or alternatively, the agent 218 may enforce network-level controls or activate the restriction on the user device usage based on the usage rules.

In some aspects, responsive to enabling the blocking, the agent 218 may additionally monitor compliance state (or compliance status) associated with the user device 102 when the user device 102 is located in the smart zone 104. The compliance state may indicate the state of the predefined permission(s) for the agent 218 to enable the unit 106 to enforce the restriction on the user device 102. Specifically, the agent 218 may monitor and determine whether the user has disabled the predefined permission(s) for the agent 218 to operate. For example, the agent 218 may determine if the user has disabled location tracking feature on the user device 102, which may prevent the agent 218 from tracking the user device’s real-time location. In addition, the agent 218 may determine if the user has disabled the VPN connection, which may prevent the agent 218 from activating the VPN based on the VPN configuration. The agent 218 may transmit information or details associated with the compliance state to the unit 106 at a predefined frequency (or based on a trigger signal), as shown in a step 316.

In further aspects, the agent 218 may continuously monitor and actively block the user device usage when the user device 102 is located inside the smart zone 104, as shown in a step 314. For instance, when the unit 106 disables access to the internet on the user device 102 (e.g., to enforce the restrictions on the user device 102), the agent 218 may monitor if the user is still using the user device 102 in the offline mode. The agent 218 may further monitor the user device usage (e.g., screen time) inside the smart zone 104. The agent 218 may transmit such information to the unit 106 (e.g., the processor 204) at step 316. In some aspects, the agent 218 may capture/monitor the user device usage information (e.g., screen time) even when the user disables the predefined permission(s) and transmit such information to the unit 106 (e.g., the processor 204).

The processor 204 (or the unit 106) may obtain the information or details associated with the compliance state and/or the usage information from the agent 218 and may store the obtained information in the memory 206. For instance, the processor 204 may store such information / data in the user information database 214. Further, responsive to obtaining the information associated with the compliance state, the processor 204 may determine or track / monitor whether the user device 102 is in a compliant state or in a non-compliant state based on the obtained information, as shown in a step 318. The user device 102 may be in a non-compliant state when the user has disabled the predefined permission(s) (e.g., the location tracking feature and/or the VPN) for the agent 218 to operate properly. In additional aspects, the processor 204 may determine that the user device 102 may be in a non-compliant state when the user removes/deletes the agent 218 from the user device 102 (e.g., when the processor 204 stops receiving any data from the agent 218). On the other hand, the user device 102 may be in the compliant state when the agent 218 has the predefined permission to operate properly on the user device 102 and the user has not removed the agent 218 from the user device 102. Responsive to determining that the user device 102 is in the non-compliant state, the processor 204 may perform one or more remedial actions, as shown in a step 320.

In some aspects, the remedial action may include outputting a third notification to the user device 102 requesting the user to enable the predefined permission for the agent 218 to operate properly. The processor 204 may output the third notification at a predefined frequency until the user provides the predefined permission to the agent 218. In further aspects, the remedial action may include outputting a fourth notification to a third party, indicating that the user has disabled the predefined permission. For instance, the processor 204 may output the fourth notification to user devices associated with the supervisor of the user, the user’s parents, and/or to the administrator. In addition, the processor 204 may output a notification to the user device when the user has disabled the predefined permission to the agent 218. For example, the processor 204 may output a notification “You've disabled a required setting, which violates your school’s phone policy. Your administrator has been notified.” In further aspects, the remedial action may include storing the information associated with the compliance state in the memory 206 (e.g., in the user information database 214). The processor 204 may store the details associated with the non- compliant state of the user device 102. The details may include metadata associated with the non-compliant state (e.g., day and time at which the user device 102 is found to be non-compliant, compliance rate, etc.), and/or measures taken (or remedial actions performed) to maintain the user device in the compliant state. The processor 204 may store all the instances associated with the non-compliance state in the user information database 214. Similarly, the processor 204 may store details associated with the user device usage (e.g., the screen time information) in the user information database 214.

In addition, the agent 218 may be configured to detect that the user device 102 is exiting the smart zone 104 based on monitoring of the user device location, as shown in a step 322. Responsive to such detection, the agent 218 may disable the blocking. For example, the agent 218 may deactivate the VPN or the VPN connection to deactivate the restriction on the user device 102, as shown in a step 324. Since the VPN connection is deactivated, the network traffic may not pass through the VPN gateway and the unit 106 may not enforce any restriction on the user device usage. Thus, when the user exits the smart zone 104, the user may use the user device 102 without any restriction.

The unit 106 may not only perform the operation of enforcing the restrictions on the user device usage inside the smart zone 104, but may also enable the administrator (e.g., the supervisor/teacher associated with the user or the unit developer/manager) to view the information associated with the user (and/or other users) via the admin interface 210. In some aspects, the processor 204 may obtain the user information from the external server 208, map the user information with the user device usage in the smart zone 104 and/or the non-compliant state of the user device 102, and display such mapped information on the admin interface 210. The processor 204 may further store this mapping in the memory 206 (e.g., in the user information database 214).

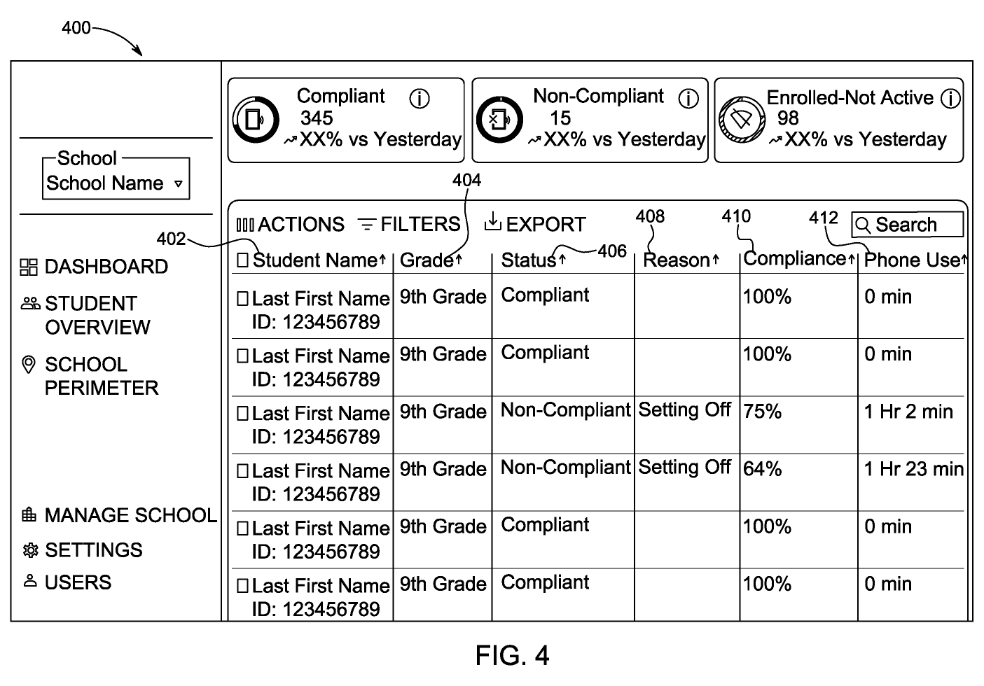

In an exemplary aspect, the processor 204 may render a dashboard 400 (shown in FIG. 4) having the user information on the admin interface 210, which enables the administrator to view the details associated with the user information (which may include the mapping described above). For instance, the processor 204 may render the non-compliant state and/or the compliant state of the user device 102 (and hence the user) on the admin interface 210. In addition, the processor 204 may render the information associated with the user device usage (e.g., a total active screen time per day) on the admin interface 210, to enable the administrator to view information associated with the user device usage via the admin interface 210. In some aspects, the processor 204 may render the dashboard 400 on the admin interface 210 when the processor 204 receives a request from the administrator to render the admin interface 210.

As shown in FIG. 4, the dashboard 400 may include/display information associated with multiple users/students associated with the education institute. The dashboard 400 depicts various user information, such as the user/student name (as shown in column 402) and grade/class associated with the user/student (as shown in column 404). In addition, the dashboard 400 may depict the status associated with the user devices associated with the respective users. For example, the dashboard 400 may depict whether the respective user device is in a compliant state or in a non-compliant state, as shown in column 406. In case the user device is in the non-compliant state, the dashboard 400 depicts a reason for the non-compliance (e.g., settings are off or the user removed the agent 218 from the user device 102), as shown in column 408. In addition, the dashboard 400 may depict a compliance rate or percentage for each user device 102, as shown in column 410. Further, the dashboard 400 may depict information associated with the user device usage, as shown in column 412. In an exemplary aspect, the dashboard 400 may depict an average screen time associated with the user device per day / month, when the user device 102 is in the non-compliant state.

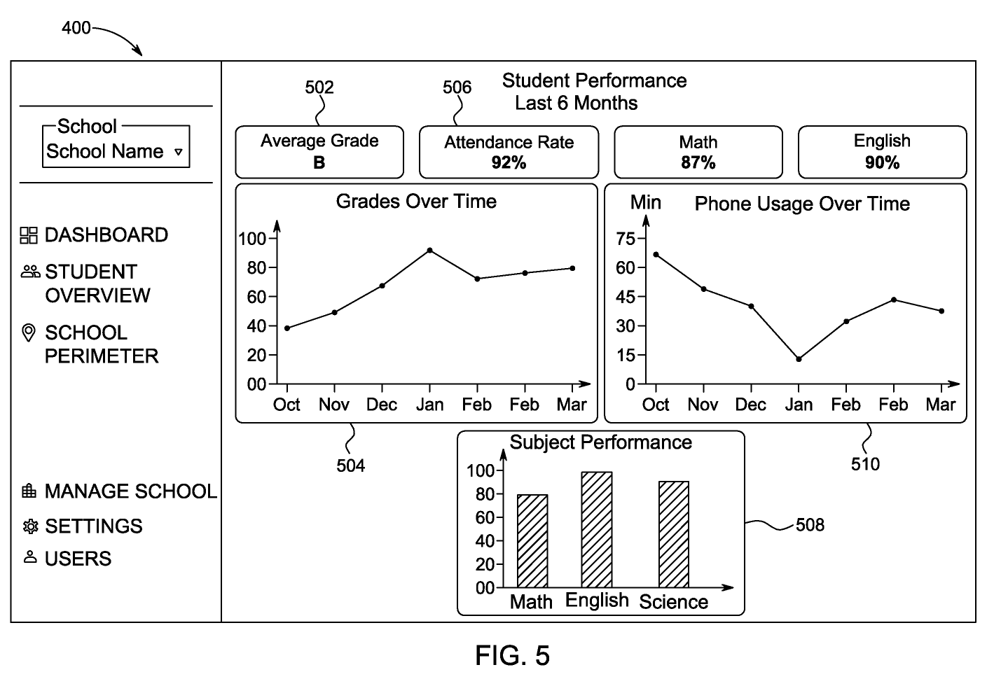

The dashboard 400 may further enable the administrator to view various details associated with a user collectively on the admin interface 210, as shown in FIG. 5. For instance, FIG. 5 depicts a user/student performance over a specific duration (e.g., last 6 months), which may enable the administrator to view different information about the user collectively, correlate all the information and counsel the user based on the correlation. In some aspects, the dashboard 400 may depict average grade associated with the user for last 6 months, as shown in view 502. In addition, the dashboard 400 may depict grades over time, as shown in view 504. The dashboard 400 may further depict attendance information associated with the user, as shown in view 506. Further, the dashboard 400 may depict subject wise performance / scores, as shown in view 508. Along with the above-mentioned information, the dashboard 400 may depict information associated with the compliant state / non – compliant state of the respective user and the user device usage information (as shown in view 510), so that the administrator may correlate the student’s performance with the user device usage in the education institute. FIG. 5 depicts charts for illustration purposes only and the dashboard 400 may depict any multi-dimensional charts to enable the administrator to view different information about the user collectively, correlate all the information and counsel the user based on the correlation.

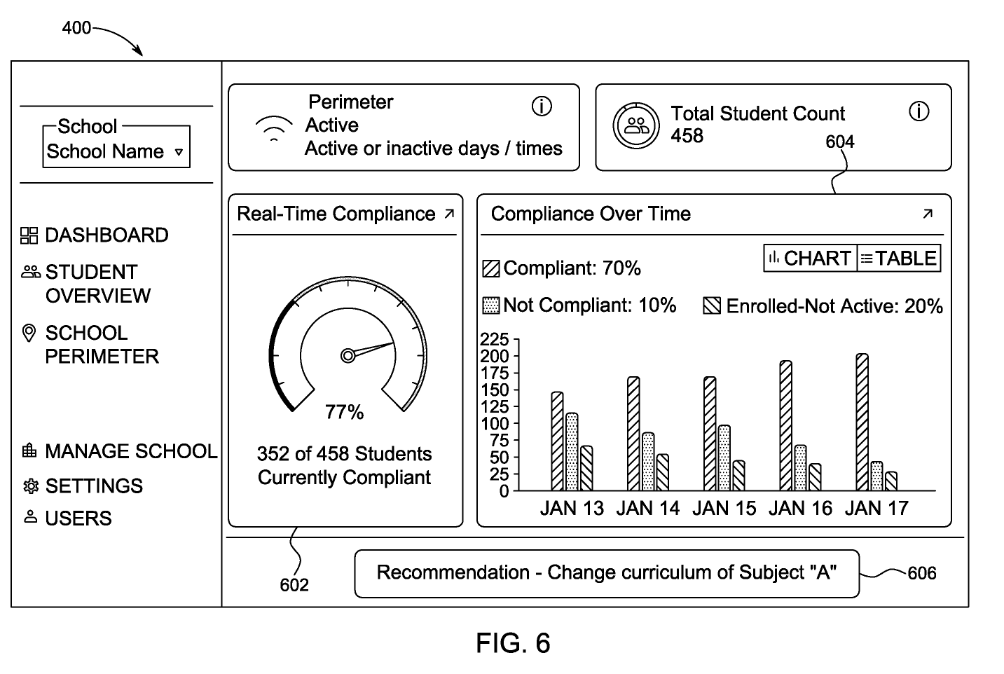

In addition, the dashboard 400 may depict overall compliance information associated with the education institute, as shown in FIG. 6. In some aspects, the dashboard 400 may depict real-time compliance status of all user devices / users associated with the education institute, as shown in view 602. For instance, the dashboard 400 may depict that 352 of 458 students are currently compliant. Further, the dashboard 400 may depict a trend of compliance status over time (e.g., for last 1 month), as shown in view 604. In some aspects, the dashboard 400 may additionally depict real-time compliance status of all user devices / users (and user device usage information) associated with multiple education institutes (e.g., in a district).

In some aspects, the processor 204 may additionally identify a trend/pattern associated with historical user device usage associated with a user in the smart zone 104. For example, the processor 204 may determine times at which the user operates the user device 102 inside the smart zone 104 (despite enforcing of the restrictions) for the last 3 or 6 months. Similarly, the processor 204 may identify the trend/pattern associated with historical compliant / non-compliant state associated with the user device 102 when the user device 102 is located in the smart zone 104, for the last 3 or 6 months.

Responsive to identifying the pattern associated with the historical user device usage (and/or the historical compliant / non-compliant state), the processor 204 may correlate the pattern with the historical user performance. The historical user performance may include assessment of the user by the user’s supervisor, such as academic grades, attendance, etc. Based on the correlation, the processor 204 may determine a recommendation to improve the user’s performance. For instance, the processor 204 may identify a trend that indicates that students of grade 9 are mostly in the non-compliant state (or use their respective user devices) between 10-11 AM (e.g., during class of subject “A”). Based on such pattern, the processor 204 may output a recommendation (as shown in view 606) on the dashboard 400 to change the curriculum of subject “A”, as the students might not be able to focus in the class of subject “A” and the changed curriculum may help. In another aspect, the processor 204 may output a recommendation to change a teaching style of subject “A” to get the attention of the supervisor. In further aspects, the processor 204 may identify the trend of multiple users (associated with a single education institute or multiple education institutes), correlate the trends, and provide a recommendation to improve the performance of users. The processor 204 may use Artificial Intelligence (AI) / Machine Learning (ML) models to determine the trends and the recommendation.

In further aspects, the processor 204 may monitor the user device usage (e.g., the screen time) associated with the user device 102 inside the smart zone 104 via the agent 218 (as described above). Based on the monitoring, the processor 204 may output a notification to the user device 102. For instance, the processor 204 may output the notification stating, “Right now is a great time to focus on learning. Try putting your phone away to stay on track.” (as a supportive prompt) or “No Phones should be out. Please put your phone away” (as a policy reminder), when the user device usage indicates that the user may be using the user device 102. In another instance, the processor 204 may output the notification stating “Nice work! You’ve followed 100% compliance today—staying focused and present. Keep it up!” (as a positive reinforcement), when the user device usage indicates that the user has not used the user device 102 during the whole day in the smart zone 104.

In further aspects, the processor 204 may identify the trend of the user device usage for 1 year (as an example) and correlate the trend with the historical user performance as described above. Based on the correlation, the processor 204 may predict a future performance outcome for the user, and may output a notification on the user device 102 indicating the predicted future performance outcome. For instance, the notification may be, “Hi user, we’ve been tracking your user device usage and your performance, and we suggest you to stay focused during these hours in this class to have a 30% better chance of getting into top 5 engineering colleges.” In some aspects, the processor 204 may predict the future performance outcome for the user based on trend analysis of other users having similar characteristics.

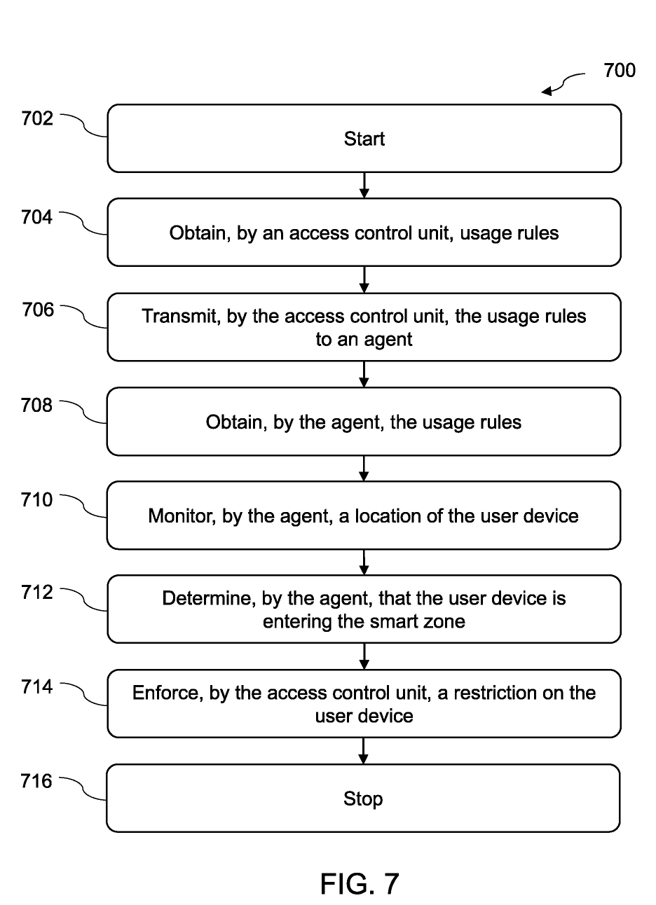

FIG. 7 depicts a flow diagram of an example method 700 to control the user device 102 in accordance with the present disclosure. FIG. 7 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 700 starts at step 702. At step 704, the method 700 may include obtaining, by the unit 106, usage rules that includes information associated with the smart zone 104 and the restriction to be enforced on the user device 102 inside the smart zone 104. At step 706, the method 700 may include transmitting, by the unit 106, the usage rules to the agent 218 responsive to obtaining the usage rules. At step 708, the method 700 may include obtaining, by the agent 218, the usage rules from the unit 106.

At step 710, the method 700 may include monitoring, by the agent 218, a user device location responsive to obtaining the usage rules. At step 712, the method 700 may include determining, by the agent 218, that the user device 102 is entering the smart zone 104 based on the monitoring of the user device location. At step 714, the method 700 may include enforcing, by the unit 106, the restriction on the user device 102 based on the usage rules when the user device 102 is located in the smart zone 104.

At step 716, the method 700 may stop.

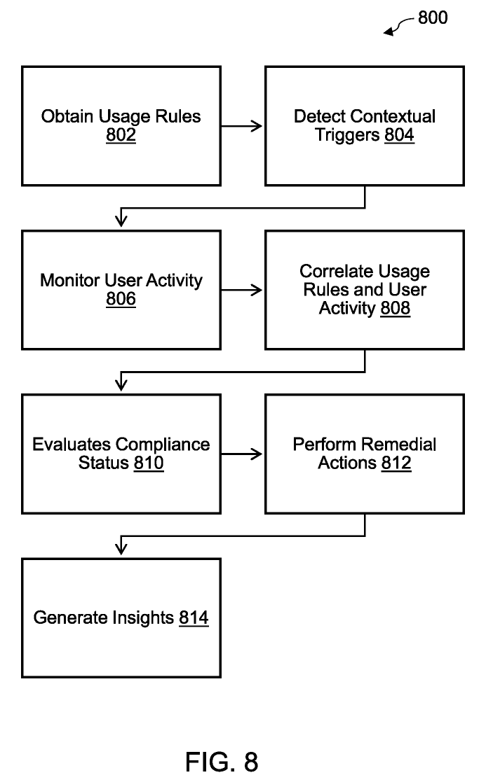

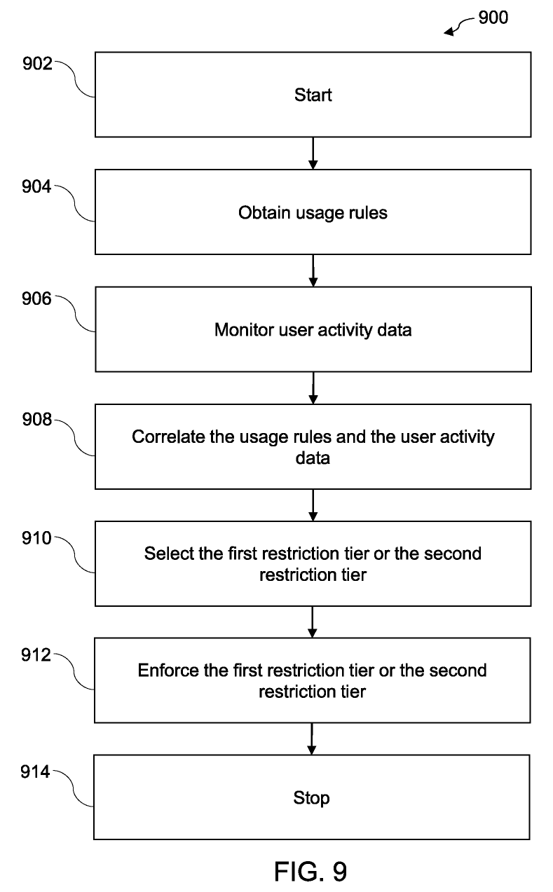

The present disclosure provides additional features to effectively manage the usage of device or application within the geographical area, as described below. The additional features are described in conjunction with FIG. 8 and FIG. 9 below.

FIG. 8 depicts an exemplary process 800 to control the user device 102 in accordance with a second embodiment of the present disclosure.

The processor 204 may first obtain / fetch the usage rules associated with the user device 102 from the usage rules database 212, as shown in step 802. The usage rules may include information associated with contextual triggers to activate or deactivate the restriction on the user device 102. The contextual triggers may include location-based triggers, non-location-based triggers, or area-specific triggers. The non-location-based triggers include scheduled or policy-based triggers, manual role-based triggers, NFC tags-based triggers, or QR code-based triggers. For example, the usage rules may include information associated with a defined location or zone in the geographical area 104 (e.g., library, classrooms, event place in the education institute or managed environment) where the restriction should be enforced on the user device 102; a defined schedule of the day at which the restriction should be activated / enforced on the user device 102 (e.g., enforce the restriction between 8 AM to 2 PM), a defined day or days (e.g., weekdays, weekends, or specific calendar dates) to enforce the restriction on the user device 102 (enforce the restriction on weekdays); a list of authorized persons (e.g., teachers) who are authorized to activate manual restrictions; predefined policy, information associated with NFC and QR codes that may enable the unit 106 to enforce restrictions, and/or the like. The usage rules may be associated with the geographical area (e.g., the education institute) and may be defined/created by the administrator via the admin interface 210.

The usage rules may further include information associated with a plurality of restriction tiers that may be enforced on the user device 102. In an exemplary aspect, the plurality of restriction tiers may include a first restriction tier that initiates a soft restriction, which includes providing a notification (e.g., a “first notification”); and one or more additional restriction tiers that imposes an active restriction on the user device 102 or application usage.

In addition, the usage rules may include information associated with an authorized usage of the user device 102 or one or more first applications (of a plurality of applications that may be installed on the user device 102) for a defined instructional purpose, time period, role, or context; and an unauthorized usage of the user device 102 or one or more second applications based on a predefined policy. For example, the usage rules may define that the unit 106 should deactivate third party applications (e.g., applications associated with social media, entertainment, etc.), the network 108, and/or other device functionality associated with the user device 102 when the user device 102 is located inside the geographical area. The unit 106 may customize the restrictions for the user device 102 based on the administrator’s preferences that the administrator defines in the usage rules, via the admin interface 210.

Specifically, the usage rules indicate “when” the restriction needs to be enforced, “what” restriction needs to be enforced, and “how” the restriction needs to be enforced. For instance, the usage rules include information associated with contextual triggers to activate and deactivate the restrictions (e.g., based on location (via geofencing or beacons), schedule (e.g., during school hours or class hours), role (e.g., student / teacher or 9^{th} / 11^{th} grader student, etc.), area-wise, and/or the like). In addition, the usage rules include information associated with selective device or application state control based on context, policy, role, schedule, or authorization state. For instance, the usage rules may indicate when to disable all the third-party applications and device functionality, and when to disable one or more third party applications installed on the user device (and/or device functionality) and selectively allow other third-party applications (e.g., health related applications) to operate on the user device 102 (and/or device functionality), based on context, policy, role, schedule, or authorization state. Further, the usage rules include information associated with tiered response model to indicate how to apply the restrictions. For instance, the usage rules may indicate that soft restrictions should be applied when usage is less, and active restrictions should be imposed when the usage is high during unauthorized use. The details of the usage rules are provided above. The agent 218 may obtain the usage rules from the unit 106, to enable the unit 106 to enforce the restrictions on the device usage or application usage.

Responsive to obtaining the usage rules, the processor 204 and/or the agent 218 may monitor (or look for) contextual triggers to activate the restriction for the user device 102 (as shown in step 804). When the processor 204 and/or the agent 218 detects one or more contextual triggers, the processor 204 and/or the agent 218 may activate the restriction for the user device 102. As described above, the contextual triggers include location-based triggers, non-location-based triggers, or area-specific triggers or combinations. In an exemplary aspect, the non-location-based triggers include scheduled or policy-based triggers, manual role-based triggers, NFC tags-based triggers, or QR code-based triggers. The examples of different triggers are provided below.

In one example, the processor 204 and/or the agent 218 may track and detect/determine whether the user device 102 is entering the geographical area 104 (e.g., education institute or specific class or zone in the education institute) via the GPS associated with the user device 102. The processor 204 and/or the agent 218 may detect the contextual trigger when the user device enters the geographical area 104. In another example, the processor 204 and/or the agent 218 may detect the contextual trigger during defined academic hours or schedule (e.g., 9 am – 3 pm). In another example, the processor 204 and/or the agent 218 may detect the contextual trigger when the user taps the user device 102 at a Near Field Communication (NFC) tag, scans a Quick-Response (QR) code, enters predefined credentials on the user device 102, and/or the like. In yet another example, the processor 204 and/or the agent 218 may detect the contextual trigger when the processor 204 and/or the agent 218 receives manual inputs from teachers / admin (e.g., teacher-initiated class mode).

Responsive to detecting the contextual trigger, the processor 204 and/or the agent 218 may start to monitor / track user activity data across the plurality of applications installed on the user device 102 and device states (as shown in step 806). Applications and device states in the user device 102 refer to the current, real-time status and activity data of the device’s hardware, operating system, and individual applications. To regulate the device usage or application usage, the processor 204 and/or the agent 218 tracks this information to enforce restrictions.

The processor 204 and/or the agent 218 may then correlate the usage rules with the user activity data, as shown in step 808. As described above, the usage rules include information associated with an authorized usage of the user device 102 or one or more first applications for a defined instructional purpose, time period, role, or context; and an unauthorized usage of the user device 102 or one or more second applications based on a predefined policy. Thus, the usage rules include details indicating which applications and device functionalities are permissible for the user device 102 based on context, policy, role, or schedule. In an exemplary aspect, the processor 204 and/or the agent 218 may correlate the usage rules with the user activity data to determine the authorization state of the user device 102. The authorization state refers to the system-level, real-time determination of whether the user device 102 or application installed in the user device 102 is allowed to operate based on the usage rules. The authorization state determines the level of access granted, acting as a gatekeeper that separates authorized, permitted activity from restricted, unauthorized usage.

For instance, the unit 106 may allow a 9^{th} grader student to use a specific education application during a specific class session, based on the usage rules defined by the administrator. When the processor 204 and/or the agent 218 detects usage of the user device 102 associated with the 9^{th} grader student, the processor 204 and/or the agent 218 may determine that the usage is authorized. However, when the 9^{th} grader student uses another application during the same class session or uses the other application in another class, the processor 204 and/or the agent 218 may determine that the usage is unauthorized. In another instance, the unit 106 may allow an 11^{th} grader student to use the user device 102 or application during lunch break only. When the processor 204 and/or the agent 218 detects usage during the lunch break, the processor 204 and/or the agent 218 may determine that the usage is authorized. However, when the student uses the user device 102 or application outside the lunch break, the processor 204 and/or the agent 218 may determine that the usage is unauthorized.

In some aspects, the processor 204 and/or the agent 218 further monitors and evaluates compliance status of the user through one or more of device state, permission status, application status, activation context, and an authorization state, as shown in step 810. Stated another way, the processor 204 and/or the agent 218 evaluates the compliance of the user through multiple signals including device state, permission status, application status, activation context, and authorization state. Usage occurring during authorized states may be interpreted differently from unauthorized usage for the purposes of compliance evaluation, analytics, reporting, and behavioral assessment.

A compliance state occurs when the user is operating the user device 102 (and/or the applications) as per the usage rules (e.g., authorized use). Conversely, an “out-of-compliance” or non-compliant state occurs when the user is not operating the user device 102 (and/or the applications) as per the usage rules. When the user is operating the user device 102 (and/or the applications) as per the usage rules, the processor 204 and/or the agent 218 may not enforce any restriction. On the other hand, when the user is not operating the user device 102 (and/or the applications) as per the usage rules, the processor 204 and/or the agent 218 may enforce one or more restrictions. In another example, the system may determine the non-compliant behavior when the user disables predefined permissions on the user device 102 (e.g., location tracking feature and/or the VPN) for the unit 106 to operate properly. The processor 204 and/or the agent 218 may log the compliance status in the user information database 214.

Responsive to a determination that the user device 102 is in the non-compliant state, the processor 204 and/or the agent 218 may perform one or more remedial actions based on the usage rules, as shown in step 812. As an example, in this case, the processor 204 and/or the agent 218 may deactivate or disable (or selectively activate or enable) third party applications (e.g., applications associated with social media, entertainment, etc.), the network 108 or other device functionalities associated with the user device 102 to control the device usage or application usage. The processor 204 and/or the agent 218 may disable all the third-party applications, or may selectively disable one or more third party applications installed on the user device 102 and selectively allow other third-party applications (e.g., health related applications) to operate. The processor 204 and/or the agent 218 may customize restrictions for the user device 102 based on the usage rules defined by the administrator.

In some aspects, to perform the remedial actions, the processor 204 and/or the agent 218 may apply / implement a tiered response / escalation model to control the user device 102 or application usage. The tiered approach to controlling multiple device and application states offers a structured, scalable method for regulating user device usage, moving from passive awareness to active, automated restriction. As described above, the usage rules may include information associated with a plurality of restriction tiers, which may enable the unit 106 to enforce different levels of restrictions on the user device 102.

An initial restriction (e.g., first restriction) tier may apply a soft restriction on the device usage or application usage. For instance, the processor 204 and/or the agent 218 may output a notification (e.g., a “first notification”) to the user, via the user device 102, indicating the device or application unauthorized usage when the first restricted tier is applied. In an example, the notification may be “Right now is a great time to focus on learning. Try putting your device away to stay on track”. In some aspects, the processor 204 and/or the agent 218 may not perform any active control (e.g., blocking of application(s) or device functions) when the first restriction tier is enforced on the user device 102. One or more subsequent restriction tiers (e.g., second restriction) may impose active restrictions on user device usage. This involves blocking of all or selective applications, or lock down all or some device functionality, etc. In some aspects, to enforce the second restriction tier, the processor 204 and/or the agent 218 may partially deactivate one or more applications on the user device 102, or defined device functions. Additionally or alternatively, to enforce the second restriction tier, the processor 204 and/or the agent 218 may output a notification (e.g., a “second notification”) to a third-part user device (e.g., parent, teacher, etc.).

The processor 204 and/or the agent 218 may use one or more content filtering, tunneling, or network-routing mechanisms, such as the Virtual Private Network (VPN), application blocking, operating system-level controls, network filtering, or equivalent technology to restrict the user device’s usage inside the geographical area 104, as described above. In some aspects, the processor 204 and/or the agent 218 may establish a VPN connection for the user device 102 to restrict the user device usage.

The processor 204 and/or the agent 218 may select and apply one or more restriction tiers based on the monitoring of device usage or application usage and the usage rules (or based on their correlation). Based on the selection, the processor 204 and/or the agent 218 may enforce the first restriction tier or the second restriction tier on the user device 102. For instance, when the user activity data shows less usage (less than a threshold value) during the unauthorized use, the processor 204 and/or the agent 218 may apply an initial restriction tier and may send a notification (e.g., guidance or intervention) to the user to stop using the device or application. After sending the notification, if the user continues to use the device or application for a prolonged time duration (e.g., greater than the threshold value), the processor 204 and/or the agent 218 may escalate enforcement to one or more subsequent restriction tiers to actively apply restrictions based on the usage rules.

The processor 204 and/or the agent 218 may automatically transition between the selection of the first restriction tier and the second restriction tier based on the user activity data. The processor 204 and/or the agent 218 may further adjust restrictions, guidance, or interventions in the tiered response model based on observed behavior, compliance patterns, or policy criteria. For instance, the processor 204 and/or the agent 218 may adjust the details associated with the first notification of the first restriction tier, and restrictions associated with the second restriction tier based on the user activity data or policy criteria. As an example, the processor 204 and/or the agent 218 may gradually increase or decrease the restriction based on the user activity data and the usage rules. In some aspects, the tiered responses may vary by individual student, policy or role, repeated behavior patterns, or historical compliance signals. The system may apply more restrictive tiers (e.g., additional OS-level controls, parental involvement, or enhanced supervision) selectively rather than universally, allowing the unit 106 to respond proportionally to demonstrated need.

In an exemplary embodiment, the steps described above may be performed by the processor 204 (via the agent 218). In another embodiment, the steps described above may be performed by a combination of the processor 204 and the agent 218. In yet another embodiment, the steps described above may be performed by the agent 218 based on inputs obtained from the processor 204.

The unit 106 (or the processor 204) may not only perform the operation of enforcing the restrictions on the user device usage, but may also generate insights (shown as block 814 in FIG. 8) from different data. To generate the insights, the processor 204 may aggregate data (e.g., device usage or application usage data) over time and generate insights based on the aggregated data. In some aspects, the processor 204 may generate behavioral, usage, and compliance insights derived from device activity, activation context, and the authorization state. Analyzing data may provide targeted, personalized insights to restrict device usage during school hours in an efficient manner. By examining when, how often, and for what purpose the student uses their phone, the processor 204 may apply the restrictions in a better manner. In addition, analyzing the data offers unique, data-driven insights to reinforce positive behaviors, moving beyond simple screen time monitoring to understand behavioral patterns, such as self-regulation. By analyzing metrics like frequency of screen-on events, app usage types, and data consumption, the education institute can foster better digital citizenship and academic focus.

The processor 204 may use the insights to perform risk identification, attendance or engagement tracking, interventions or support workflow generation, or incentive or reward program identification. For example, the processor 204 may use the insights to detect potential academic, mental, or physical health issues. In addition, the processor 204 may provide support or personalized content to the user based on the insights, which would reinforce positive behavior in the user.

The processor 204 may provide incentive or reward program based on the insights. For instance, the processor 204 may output a notification on the user device 102, e.g., “Based on the recent usage logs, you have done an outstanding job of managing your device during class, only checking it during appropriate times. This demonstrates excellent self-control and maturity, allowing you to stay fully engaged in learning. Keeping this up shows you are taking responsibility for your academic environment.” As another example, the processor 204 may output a notification, e.g., “Your device usage data shows a very low number of screen checks during the day, which suggests you are deeply focused on your schoolwork and interacting with peers. This high level of attention is a fantastic behavior that helps with both your academics and building strong, real-world relationships.” The processor 204 may synchronize such insights with external systems (e.g., student information systems or other school platforms). The unit 106 is designed to feed insights outward rather than solely displaying dashboards internally, enabling downstream use of unit-generated intelligence.

In addition, to reinforce positive behavior in the user, the processor 204 may aggregate compliance history, authorization states, and device interaction signals for different users and classify the users into performance-based cohorts. For instance, the processor 204 may classify the users into consistently compliant users; intermittently compliant users; or users exhibiting repeated difficulty maintaining compliance. Based on such classifications, the processor 204 may deliver differentiated guidance, encouragement, educational content, or supportive messaging intended to reinforce positive behavior and support sustainable habit formation. The processor 204 may deliver behavioral reinforcement content within the application associated with the system or through approved communication channels, which operate in coordination with the unit’s compliance monitoring, authorization states, and tiered response model.

Making these cohorts helps in several crucial ways. For instance, it allows for high-precision, personalized engagement. A “high screen-time cohort” (or consistently incompliant users) can receive personalized content, such as tips for reducing screen time or promoting a “focus mode,” while a “productive cohort” (or consistently compliant users) could be rewarded with incentives for maintaining their habits, thus reinforcing positive behavior. Using cohort analysis is critical for understanding the “why” behind user behavior, which in turn helps in creating, as a result, a more effective approach by focusing on user behavior.

FIG. 9 depicts a flow diagram of an example method 900 to control a user device in accordance with second embodiment of the present disclosure. FIG. 9 may be described with continued reference to prior figures. The following process is exemplary and not confined to the steps described hereafter. Moreover, alternative embodiments may include more or less steps than are shown or described herein and may include these steps in a different order than the order described in the following example embodiments. The steps mentioned below may be performed by the unit 106, the agent 218, or a combination thereof.

The method 900 starts at step 902. At step 904, the method 900 may include obtaining the usage rules from the memory 206. At step 906, the method 900 may include monitoring user activity data across a plurality of applications and device states on the user device 102. The user device 102 may include a mobile phone, tablet, wearable device, laptop computer, or other personal computing device capable of executing applications and communicating with the system. At step 908, the method 900 may include correlating the usage rules and the user activity data. At step 910, the method 900 may include selecting one or more restriction tiers for the user device 102 based on the correlation. At step 912, the method 900 may include enforcing the selected restriction tier or tiers on the user device 102 based on the selection.

At step 914, the method 900 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A system comprising:
a memory configured to store usage rules associated with a user device of a user; and a processor configured to:
obtain the usage rules from the memory, wherein the usage rules comprise information associated with restriction on the user device;
monitor user activity data or device state signals across a plurality of applications and device states on the user device;
correlate the usage rules and the user activity data or the device state signals to determine an authorization state;
monitor and evaluate compliance status of the user based on the authorization state; and
perform a remedial action based on the usage rules and the compliance status, wherein the remedial action includes limiting or modifying access to one or more applications or device functions on the user device.

2. The system of claim 1, wherein the usage rules comprise information associated with a plurality of restriction tiers, and wherein the plurality of restriction tiers comprises:
a first restriction tier that initiates a soft restriction, the soft restriction comprising providing a first notification or guidance messages; and
a second restriction tier that imposes an active restriction on the user device or an application on the user device.

3. The system of claim 2, wherein the processor is further configured to:
select the first restriction tier or the second restriction tier for the user device based on the compliance status; and
enforce the first restriction tier or the second restriction tier on the user device based on the selection, to perform the remedial action.

4. The system of claim 3, wherein the processor is further configured to automatically transition the selection between the first restriction tier and the second restriction tier based on the user activity data.

5. The system of claim 3, wherein the processor is further configured to adjust details associated with the first notification of the first restriction tier, and restrictions associated with the second restriction tier based on the user activity data or policy criteria.

6. The system of claim 3, wherein the processor is further configured to:
detect contextual triggers to implement the soft restriction or the active restriction for the user device; and
monitor the user activity data across the plurality of applications and the device state signals on the user device responsive to detection of the contextual triggers.

7. The system of claim 6, wherein the contextual triggers comprise location-based triggers, non-location-based triggers, or area-specific triggers, and wherein the non-location-based triggers comprise scheduled or policy-based triggers, manual role-based triggers, NFC tags-based triggers, or QR code-based triggers or other proximity-based interaction triggers.

8. The system of claim 7, wherein the contextual triggers are selected by an administration entity.

9. The system of claim 1, wherein the usage rules comprise information associated with:
an authorized usage of the user device or one or more first applications, of the plurality of applications, for a defined instructional purpose, time period, role, or context; and
an unauthorized usage of the user device or one or more second applications, of the plurality of applications, based on a policy.

10. The system of claim 1, wherein the usage rules are defined by an administrator.

11. The system of claim 3, wherein, to enforce the second restriction tier, the processor partially deactivates one or more applications, from the plurality of applications, or defined device functions.

12. The system of claim 3, wherein, to enforce the second restriction tier, the processor outputs a second notification to a third-part user device.

13. The system of claim 1, wherein the processor is further configured to monitor and evaluate the compliance status of the user through one or more of device state, permission status, application status, or activation context.

14. The system of claim 1, wherein the processor is further configured to:
generate insights based on the monitoring of the compliance status or the user activity data; and
perform, based on the insights, one or more of: risk identification, attendance or engagement tracking, interventions or support workflow generation, or incentive or reward program identification.

15. The system of claim 14, wherein the processor is further configured to classify the user into a consistently compliant user, an intermittently compliant user, or a consistently incompliant user based on the insights.

16. The system of claim 15, wherein the processor is further configured to output, based on the classification, differentiated guidance, encouragement, educational content, or supportive messaging intended to reinforce positive behavior and support sustainable habit formation to the user.

17. A method comprising:
obtaining, by a processor, usage rules associated with a user device of a user, wherein the usage rules comprise information associated with restriction on the user device;
monitoring, by the processor, user activity data across a plurality of applications and device state signals on the user device;
correlating, by the processor, the usage rules and the user activity data or the device state signals to determine an authorization state;
monitoring and evaluating, by the processor, compliance status of the user based on the authorization state; and
performing, by the processor, a remedial action based on the usage rules and the compliance status, wherein the remedial action includes limiting or modifying access to one or more applications or device functions on the user device.

18. The method of claim 17, wherein the usage rules comprise information associated with a plurality of restriction tiers, and wherein the plurality of restriction tiers comprises:
a first restriction tier that initiates a soft restriction, the soft restriction comprising providing a first notification or guidance messages; and
a second restriction tier that imposes an active restriction on the user device or an application on the user device.

19. The method of claim 18 further comprising:
selecting the first restriction tier or the second restriction tier for the user device based on the compliance status; and
enforcing the first restriction tier or the second restriction tier on the user device based on the selection, to perform the remedial action.

20. A non-transitory computer-readable storage medium having instructions stored thereupon which, when executed by a processor, cause the processor to:
obtain usage rules associated with a user device of a user, wherein the usage rules comprise information associated with restriction on the user device;
monitor user activity data across a plurality of applications and device state signals on the user device;
correlate the usage rules and the user activity data or the device state signals to determine an authorization state;
monitor and evaluate compliance status of the user based on the authorization state; and perform a remedial action based on the usage rules and the compliance status, wherein
the remedial action includes limiting or modifying access to one or more applications or device functions on the user device.
